(19) United States
(12) Patent Application Publication
(10) Pub. No.: US 2013/0027316 A1
(43) Pub. Date: Jan. 31, 2013

(54) USER INTERFACE AND METHOD FOR MANAGING A USER INTERFACE STATE BETWEEN A LOCK STATE AND AN UNLOCK STATE

(71) Applicant: Venkata S. Akella, Sunnyvale, CA (US)

(72) Inventor: Venkata S. Akella, Sunnyvale, CA (US)

(73) Assignee: MOTOROLA MOBILITY, INC., Libertyville, IL (US)

(21) Appl. No.: 13/190,842

(22) Filed: Jul. 26, 2011

(51) Int. Cl. G06F 3/041

(52) U.S. Cl. 345/173

(57) ABSTRACT

A user interface for an electronic device and method for managing a state of a user interface between a lock state and an unlock state are provided. The user interface has a touch sensitive display having a display surface, the touch sensitive display being adapted for presenting to a user at a respective position at least one display element along the display surface. The touch sensitive display is further adapted for receiving from the user, a user interaction with the touch sensitive display at a location along the display surface. The user interface further includes a controller, where the controller includes a user interface state module having an unlock state and a lock state adapted for selectively enabling and disabling at least a portion of the user interface. The controller further includes a state change module adapted for switching the state of the user interface state module between the lock state and the unlock state. The state change module switches the state of the user interface module from the lock state to the unlock state when the state change module detects each of the at least one display elements in respective unlock position for the corresponding one of the at least one display elements. The controller still further includes a lock state interface module, said lock state interface module being adapted to detect a received user interaction that is initiated with a selection of one of the at least one display element having a variable start zone. The lock state interface module includes a start zone movement module where prior to the selection of the display element by the user, the variable start zone of the display element moves along the display surface as a function of time, such that the variable start zone has a first location at a first point in time, and the variable start zone has a second location at a second point in time, which is different than the first location.

### FIELD OF THE DISCLOSURE

The present disclosure relates generally to managing a user interface state between a lock state and an unlock state and, more particularly, to the movement of a display element between an area of display surface corresponding to a locked position and an area of the display surface corresponding to an unlocked position, where prior to selection by the user the display element has a variable start zone in which the display element moves in a pattern having a predefined manner.

### BACKGROUND

The use of touch sensitive interfaces, including those incorporated as part of a touch sensitive display have gained in popularity for their ease of use associated with a more intuitive interaction in accessing and controlling the functionality of an electronic device including interacting with displayed elements and/or information. Furthermore, touch sensitive displays have greatly expanded the types of user interactions which can be regarded as a valid form of input. Many interfaces have made use of these expanded opportunities to extend the types of interactions that can be defined for interacting with the device and more particularly the various applications running on the device. These interactions have been expanded to included what has sometimes been referred to as gestures. In some cases, a gesture can be as concise as a brush across the touch sensitive surface. In other instances, a gesture can trace complicated patterns and include multiple points of interaction with the surface. In at least some instances, the location at which the gesture begins can be used to select a particular one of the elements being displayed with which the user wishes to interact, and the subsequent traced movement along the surface of the display defines the nature of the interaction with the displayed element selected by the user. Still further, many interfaces have been designed to allow corresponding functionality to be performed in simple and succinct ways with a trend toward involving a minimal number of steps and/or interactions which, in essence, involves a streamlining of the interactions necessary for producing a desired effect.

Correspondingly, by increasing the types of interactions that will be viewed as a valid form of input and minimizing the number of steps to produce and/or trigger a corresponding function, there is an increased chance that an unintended interaction will coincide with an interaction from the expanded list of permissible types of gestures or interactions with the possibility that it will trigger an unintended consequence. In essence, any stray movement of a body part of the user relative to the touch sensitive surface of the display has the potential to select an item being displayed with which the user can interact, and correspondingly the nature of the movement has the potential that it will be recognized as a gesture associated with a valid function that will be acted upon, and/or may trigger an action relative to the selected item. In some cases, the stray movement which is not intended to be a purposeful interaction may be repeated in a regular fashion, which can compound or magnify the resulting interaction. For example, a user's hip or leg might brush against the display surface of the device with each step as a user walks while carrying the device. Correspondingly, each stray movement, or the repeated movements when considered together, has the potential to be treated as a valid interaction despite its unintended origins.

As such, with expanded types of interactions and a set of streamlined interactions for producing an effect, it has become increasingly likely that a user can unknowingly activate functionality on the device, such as initiate a telephone call or manipulate a stored element, such as a file, including accidentally moving, copying or erasing the same through a stray interaction. In response to this, user interface developers have implemented lock screens, which temporarily disable at least a portion of the user interface, and generally require an unlock interaction before other types of interactions will be recognized. In some cases, the lock screen will be engaged after a fixed period of inactivity during which the user has not interacted with the device.

However for the same reasons that users desire more streamlined user interactions for producing desired and intended functionality, any interaction associated with the unlocking of a locked user interface should similarly avoid being overly burdensome or complex, in order to avoid the user finding the use of the feature frustrating, and correspondingly disabling the feature. Hence the challenge is to develop and provide a straight forward and intuitive interaction for unlocking a locked device which is not overly burdensome, but which also can not readily be accidently initiated.

Correspondingly, the present inventors have recognized that it would be beneficial to develop an apparatus and/or approach for transitioning between a user interface lock state and a user interface unlock state, which is intuitive and not unduly burdensome to the user, while simultaneously reducing the risk that a stray or unintended interaction could accidently transition the device to an unlock state without the transition to the unlock state being the express intent of the user of the device.

### SUMMARY

The present disclosure provides among other features a user interface for an electronic device or other machine. The user interface has a touch sensitive display having a display surface, the touch sensitive display being adapted for presenting to a user at a respective position at least one display element along the display surface. The touch sensitive display is further adapted for receiving from the user, a user interaction with the touch sensitive display at a location along the display surface. The user interface further includes a controller. The controller includes a user interface state module having an unlock state and a lock state adapted for selectively enabling and disabling at least a portion of the user interface, wherein the portion of the user interface responds to a predetermined type of user interaction when in the unlock state and does not respond to the predetermined type of user interaction when in the lock state. The controller further includes a state change module adapted for switching the state of the user interface state module between the lock state and the unlock state. The state change module switches the state of the user interface module from the lock state to the unlock state when the state change module detects each of the at least one display elements in respective unlock position for the corresponding one of the at least one display elements, wherein the respective unlock position for the corresponding one of the at least one display element includes placement within a respective predetermined area. The controller still further includes a lock state interface module, said lock state interface module being adapted to detect a received user interaction that is initiated with a selection of one of the at least one display element having a variable start zone. The lock state interface module includes a start zone movement module where prior to the selection of the display element by the user, the variable start zone of the display element moves in a pattern having a predefined manner along the display surface as a function of time, such that the variable start zone has a first location relative to the display surface at a first point in time, and the variable start zone has a second location relative to the display surface at a second point in time, which is different than the first location.

In at least one embodiment, the received user interaction includes a post selection gesture, which moves the selected one of the at least one display element from the variable start zone to a post gesture position having a placement in a new area.

In at least a further embodiment, the received user interaction includes a post selection gesture, which includes a path having a direction which is traced proximate the display surface of the touch sensitive display by the user using a pointer having a position that moves along the path, wherein a further movement of the variable start zone of the at least one display element is biased in the direction of the path of the post selection gesture.

In at least a still further embodiment, the user interface additionally includes a movement sensor, for detecting a movement of the electronic device initiated by the user, which could then be used to affect the movement of the variable start zone of the at least one display element.

The present disclosure further provides a method for managing a state of a user interface between a locked state and an unlocked state. The method includes switching a state of the user interface from the unlocked state to the locked state. At least one display element is then presented to the user via a display surface of a touch sensitive display. Each of the at least one display elements is presented at a respective variable start zone, where prior to selection by the user, the variable start zone of the display element moves in a pattern having a predefined manner along the display surface as a function of time, such that the variable start zone has a first location relative to the display surface at a first point in time, and the variable start zone has a second location relative to the display surface at a second point in time, which is different than the first location. When the state of the user interface is switched from the unlocked state to the locked state, the at least one display element is positioned in an area of the display surface other than a predetermined area of a respective unlock position. Detecting via the touch sensitive display a user interaction proximate the display surface, the user interaction including a selection by the user of one of the at least one display element and a postselection gesture, which affects the movement of the display element. When each of the at least one display element is detected in the respective unlock position of the corresponding at least one display element, the state of the user interface is then switched from the locked state to the unlocked state.

These and other objects, features, and advantages of this disclosure are evident from the following description of one or more preferred embodiments of this invention, with reference to the accompanying drawings.

### BRIEF DESCRIPTION OF THE DRAWING

FIG. 1 is a plan view of an exemplary electronic device incorporating a touch sensitive interface, such as a touch sensitive display, for receiving a user interaction relative to one or more interactive elements;

FIG. 2 is a plan view of a pointer device engaging a touch sensitive surface and tracing a potential exemplary single pointer pattern movement that might be effective as a gesture;

FIG. 3 is a block diagram of a user interface incorporated as part of an electronic device;

FIG. 4 is a plan view of a touch sensitive display illustrating a user interface while in a locked state and a potential user gesture for interacting with the display element;

FIG. 5 is a partial plan view of a display element highlighting the movement of the display element proximate a boundary between a variable start zone and a zone defining an unlock area;

FIG. 6 is a further plan view of a touch sensitive display illustrating a user interface while in a lock state and a potential user gesture for interacting with the display element;

FIG. 7 are a pair of different motion vectors illustrating the effect of one potential exemplary gesture on the movement of a display element having each one of the different motion vectors;

FIG. 8 is a isometric view of the touch sensitive display illustrating the effect upon a display element of a further potential exemplary gesture including the tilting of the plane of the display;

FIG. 9 is a plan view of the touch sensitive display illustrating still further potential exemplary gestures; and

FIG. 10 is a flow diagram of a method for managing a state of a user interface between a locked state and an unlocked state.

### DETAILED DESCRIPTION

While the present disclosure is susceptible of embodiments in various forms, there is shown in the drawings and will hereinafter be described presently preferred embodiments with the understanding that the present disclosure is to be considered an exemplification of the invention and is not intended to limit the invention to the specific embodiments illustrated. Furthermore, while the various figures are intended to illustrate the various aspects of the present invention, in doing so, the elements are not necessarily intended to be drawn to scale. In other words, the size, shape and dimensions of some layers, features, components and/or regions for purposes of clarity or for purposes of better describing or illustrating the concepts intended to be conveyed may be exaggerated and/or emphasized relative to other illustrated elements.

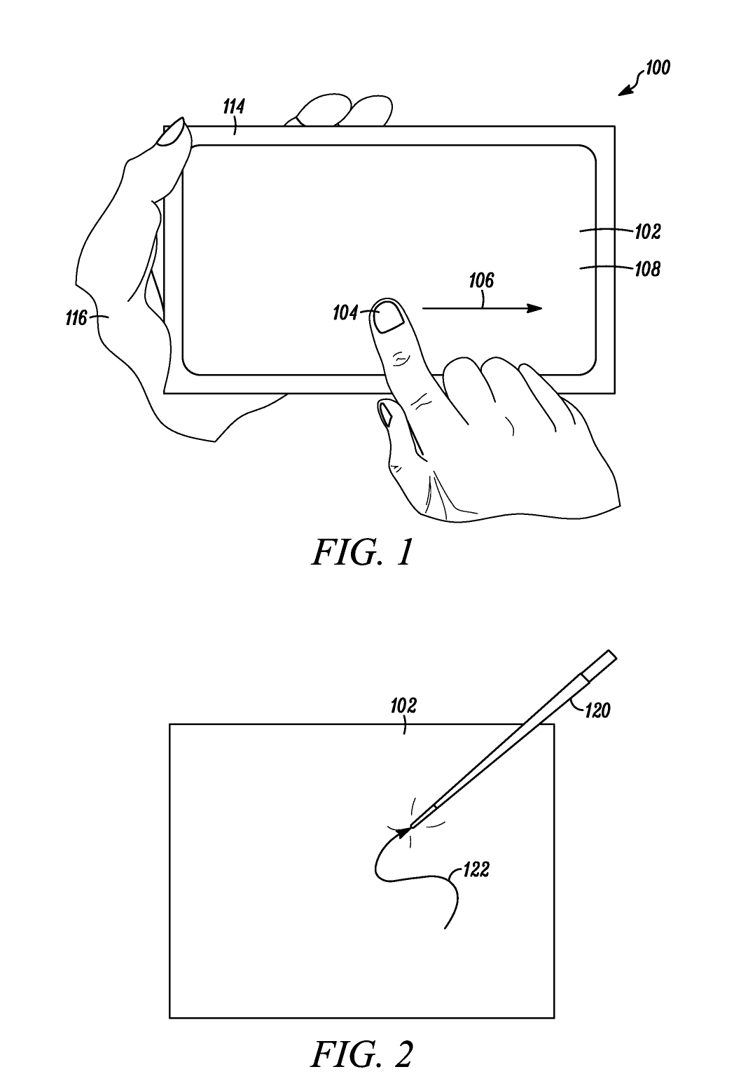

FIG. 1 illustrates a plan view of an exemplary electronic device 100 incorporating a touch sensitive interface 102. In the particular embodiment illustrated, the touch sensitive interface 102 is incorporated as part of a touch sensitive display 108, where a surface coincides with and extends to include a display, which provides information visually to the user. The surface is adapted to receive an input from a pointer, such as a user's finger 104 or other appendage, or a stylus (not shown), where the nature of the interaction of the pointer with the sensor surface defines a pattern of interaction and any related gesture 106 or movement. For example, the pattern of interaction may include touching or contacting a point on the touch sensitive interface with the pointer, or navigation or other movement of the pointer along or across the touch sensitive interface while contacting the interface or being within a predefined proximity of the interface, among other interactions between the pointer and the touch sensitive interface. The electronic device could be one of many different types of electronic devices including wireless communication devices, such as radio frequency (i.e., cellular) telephones, media (i.e., music, video) players, personal digital assistants, portable video gaming devices, cameras, and/or remote controls. The electronic device may also be a user input subassembly of some other equipment, like an appliance or other machine.

The touch sensitive user interface 102 often includes a touch sensitive array, which has position sensors that are adapted for detecting a relative position and/or proximity of a corresponding pointer device relative to the touch sensitive user interface 102. Many existing forms of touch sensitive arrays include arrays which are resistive or capacitive in nature. Still further, the touch sensitive array can even employ a force sensing element array for detecting an amount of force being applied at the selected location. In this way, a force threshold determination can be taken into account in determining an intended interaction including the selection of an interactive element, such as a display element, or the making of a gesture. However, the use of other forms of touch sensitive arrays are possible without departing from the teachings of the present disclosure.

While the pointer device can include a user's finger 104, a stylus, or any other suitable often times generally elongated element for identifying a particular area associated with the touch sensitive array, in some instances, the determination of an appropriate pointer may be affected by the particular technology used for the touch sensitive array, where in some instances a particular type of pointer may work better in conjunction with a particular type of array. In FIG. 1, the device 100 is illustrated as being held by a hand 116 on at least one of the (i.e. the left) sides 114 with the other hand, and more particularly a finger 104 of the other hand, being used to interact with the surface of the display of the touch sensitive user interface. Through the use of a finger 104 or a stylus, a user can produce a gesture 106 that can be detected by the device 100 through an interaction with the touch sensitive interface 102.

FIG. 2 illustrates an example of a pointer device 120 engaging a touch sensitive surface 102 and tracing a potential exemplary single pointer pattern movement 122 that might be effective as a gesture for adjusting the performance of an active controllable interface function. While generally a pointer is used to interact with the touch sensitive user interface, in reality the proximity of any item relative to the touch sensitive surface can sometime be detectable as an interaction, whether intended or not. For example, if the device is brought within proximity of a user's face, in instances where the device supports telephone calls, the user's cheek brushing up against the device has the potential of being detected as a user interaction. As such, devices have used lock screens to help reduce the circumstances in which anticipated or unanticipated unintended interactions are erroneously detected as a device input. However, because a user needs to be able to navigate away from the lock state in order to interact with the device, but at the same time you do not want the device to be accidently unlocked by the same unintended interactions that the lock screen was intended to filter, the lock screen and the particular action on the part of the user necessary for unlocking the device, become a balance between effectively filtering unintended interactions, and not requiring an overly complex interaction for enabling the user to transition the device back to an unlocked state.

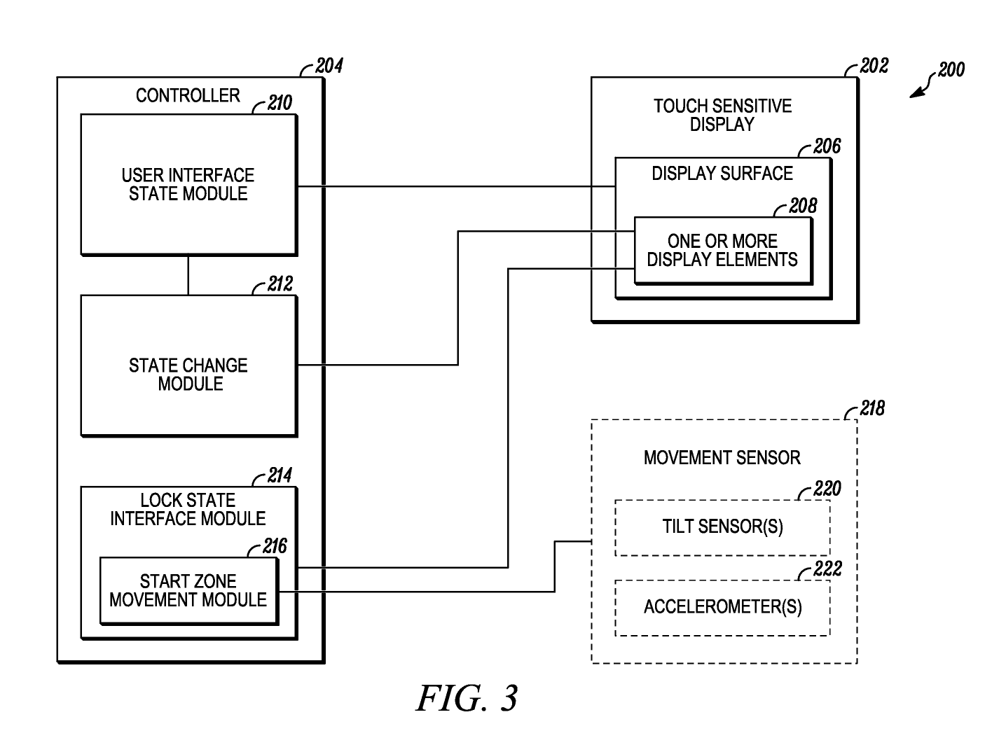

FIG. 3 illustrates a block diagram 200 of a user interface incorporated as part of an electronic device. The user interface includes a touch sensitive display 202 and a controller 204. The touch sensitive interface 202 includes a display surface 206 including one or more display elements 208 for presentation to the user via the display surface with which the user can interact. The display surface 206 of the touch sensitive display is adapted for receiving a gesture or pattern of interaction from a user either directly, for example 106 in FIG. 1, or indirectly via a pointing device, for example 122 in FIG. 2. The detected gesture or pattern of interaction can then be interpreted in order to discern a desired action on the part of the user.

However as noted previously not all interactions detected via the touch sensitive display may be the result of a desired action on the part of the user. In some instances an unintended interaction with the device may be made and detected proximate the touch sensitive surface of the device. As such, in some circumstances, it may be desirable to have the touch sensitive surface be in a lock state, which limits the nature and type of interactions that will be detected as a valid user input. Generally, while in a locked state the user interface will be focused on those particular actions which are intended on contributing to the transition of the user interface back to an unlocked state. The state of the user interface between a locked state and an unlocked state is managed by the controller 204. In support of this function, the controller 204 includes a user interface state module 210, which selectively enables and disables at least a portion of the user interface, including the types of interactions to which the interface will respond.

The controller further includes a state change module 212, which is adapted for switching the state of the user interface, which is managed by the user interface state module 210, between a lock state and an unlock state. The state change module switches the state of the user interface module from the lock state to the unlock state when the state change module detects each of at least one display element in its respective unlock position, which generally includes placement within a respective predetermined area. The controller still further includes a lock state interface module 214 which manages the functioning of at least a portion of the device while the user interface is in a locked state. As part of that management, the lock state interface module 214 may monitor interactions with the touch sensitive surface of the display, and detect interactions with elements being displayed during the locked state of the interface state module 210. The lock state interface module further manages the elements being displayed including their subsequent selection and movement including those prompted by the user, as well as those that occur while the device is in a locked state.

When in a locked state, the user interface provides at least one display element having a variable start zone managed by a start zone movement module 216 of the lock state interface. Prior to a valid selection of the display element, the start zone movement module 216 will manage the movement of the corresponding display elements in a pattern having a predefined manner of movement along the display surface as a function of time. The movement results in the display element having a variable start zone. In other words, the display element has a first location relative to the display surface at a first point in time and a second location relative to the display surface at a second point in time which is different than the first location.

In at least some instances, the act of unlocking may require a selection of a display element, and corresponding movement of the display element from a lock area to an unlock area. In these instances, in order to interact with the display element, the user needs to initiate a selection of the display element. Because the display element is moving as a function of time, the selection of the display element needs to coincide with the current position of the display element. As such, at different points of time the user will need to initiate selection of the display element by interacting with a different portion of the display surface. While a user can visually detect a display element's current position, unintended interactions are generally blind, correspondingly an unintended interaction will only select a particular display element in instances where the unintended interaction coincides with the current variable start zone location of the display element, when the unintended interaction with the display surface is first detected.

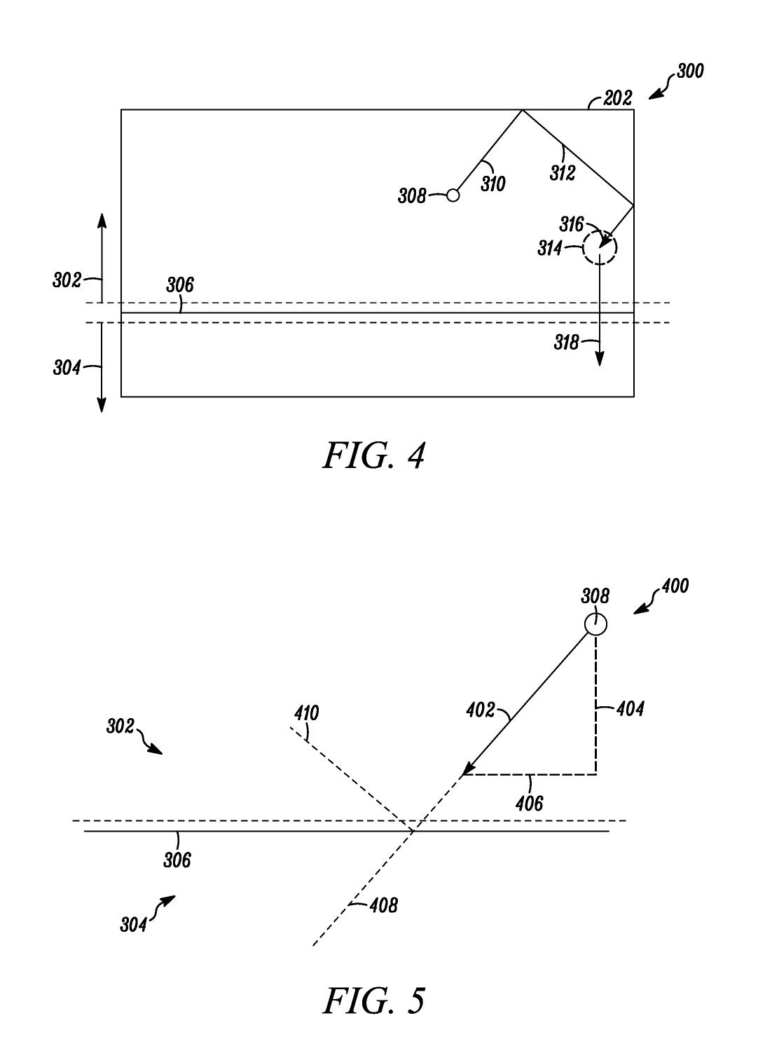

FIG. 4 illustrates a plan view 300 of a touch sensitive display 202 showing a user interface while in a locked state and a potential user gesture for interacting with the display element. In such a state, the user interface includes a lock area 302 and an unlock area 304, which is separated by a boundary line 306. While the user interface is in a locked state, the user interface presents to the user at least one display element 308, which has a pattern of movement in a predefined manner. In the present instance, the display element 308 has a direction of movement 310 along which the display element 308 will travel until it interacts with a boundary of the lock area within which it is currently located, which may or may not coincide with a boundary of the display surface. Upon interaction with the boundary, if the boundary is not the boundary separating the lock area 302 from the unlock area 304, the display element will generally bounce off of the boundary redirecting its current direction 312 of movement in a pattern that reflects the interaction with the corresponding boundary. The boundary between the lock area 302 and the unlock area 304 in at least some instances may behave similarly and result in a corresponding reflection, or as later discussed in other instances depending upon the current movement of the display element may allow the display element to pass through to the unlock area. In some instances, a user through interaction with the display element 308 can carry the display element across the boundary 306. In other instances, the user can induce a change in the current movement of the display element 308, which will enable the display element to transition across the boundary 306.

As noted previously, the variable nature of the starting zone of the display element necessitates that any selection of the display element through the use of a pointing element provide that the location of the selection coincide with the current position of the display element. In FIG. 4, an area of selection 314, corresponds to the arrow head 316 at the end of the illustrated pattern of movement. If the initiation of the gesture corresponding to the area of selection 314 coincides with the current position of the display element at the time of selection, the corresponding postselection gesture in the form of an arrow 318 defining a subsequent path of movement traced by the interacting element, such as a pointer or the user's finger, can serve to carry the display element 308 from one position on the display surface 202 to another position on the display surface. In the present instance, the postselection gesture would serve to carry the display element across the boundary 306 from the area corresponding to the lock area 302 to the area corresponding to the unlock area 304. Such a relocation of the display element, where allowed, would be sufficient for initiating a change in state of the user interface from a locked state to an unlocked state. The user could then interact with the device without portions of the user interface having been disabled. In at least some instances the area associated with the lock area 302 for a particular display element is larger than the area associated with the unlock area 304.

In addition to or as an alternative to being able to select and relocate the current position of the display element to a new area through a postselection gesture, the display element may be able to transition across boundary 306 dependent upon the current motion vector 402 attributed to the display element 308. FIG. 5 illustrates a partial plan view 400 of a display element 308 highlighting the movement of the display element proximate the boundary 306 between a variable start zone located within a lock area and a zone defining an unlock area. The motion vector 402 defines a magnitude and direction of movement of the display element 308 during a particular preset period of time. As the direction and the speed of the display element changes, the direction and the length of the corresponding motion vector 402 will similarly change. The motion vector includes two components, a component 404 which defines the speed of movement in a direction perpendicular to the boundary 306, and a component 406 which defines the speed of movement in a direction parallel to the boundary. In some embodiments, it may be possible for the display element to traverse the boundary if the speed of movement in a direction perpendicular to the boundary 306, graphically represented in the drawing as vector component 404, is greater than a predefined threshold. If the magnitude of the perpendicular vector component 404 is greater than the predefined threshold, the path of the display element will continue across 408 the boundary 306 and into the unlock area 304. If the magnitude of the perpendicular vector component 404 is less than the predefined threshold, the path of the display element will repelled by the boundary 306 in a corresponding reflected direction 410. When the user interface is initially changed to a locked state, the initial motion vector associated with any of the one or more display elements is generally below the threshold necessary for traversing the boundary 306 between the lock area 302 and the unlock area 304.

In the case where it is possible for the display element to transition across the boundary 306 between the lock area 302 and the unlock area 304 dependent upon the magnitude of the speed of movement in the direction perpendicular to the boundary exceeding a predetermined threshold when the path of the display element interacts with the boundary 306, a gesture detected relative to the display surface 206 of the touch sensitive display may impart a change in the movement of display element. This may be the case for a detected gesture regardless as to whether the initiation of the gesture coincides with the current location of the display element 308. In such an instance as illustrated in the partial plan view 500 of FIG. 5, it is possible for a gesture 502 to be received, which includes a beginning and an end that can be used to determine a direction. The determined direction can be used to define a velocity vector that is to be added to the current velocity of the display element 308. Depending upon when the gesture is received relative to the movement of the display element 308, the velocity vector being added to the display element can alter the speed and direction of the display element by either reducing the velocity of the display element or increasing the velocity of the display element. If the gesture 502 defining the vector is received during the first portion 504 of the illustrated path, the gesture will generally increase the speed of the display element 308, where alternatively if the gesture 502 is received during the third portion 506 of the illustrated path, the gesture will generally decrease the speed of the display element 308. Because the direction of the display element changes over time, a similar gesture randomly repeated multiple times will generally average out to have little to no aggregate effect. Alternatively, a user can appropriately apply the gesture at times during which the corresponding affect will bias the motion of the display element in the desired direction, so as to enable the display element to reach a velocity which is sufficient for traversing the boundary 306.

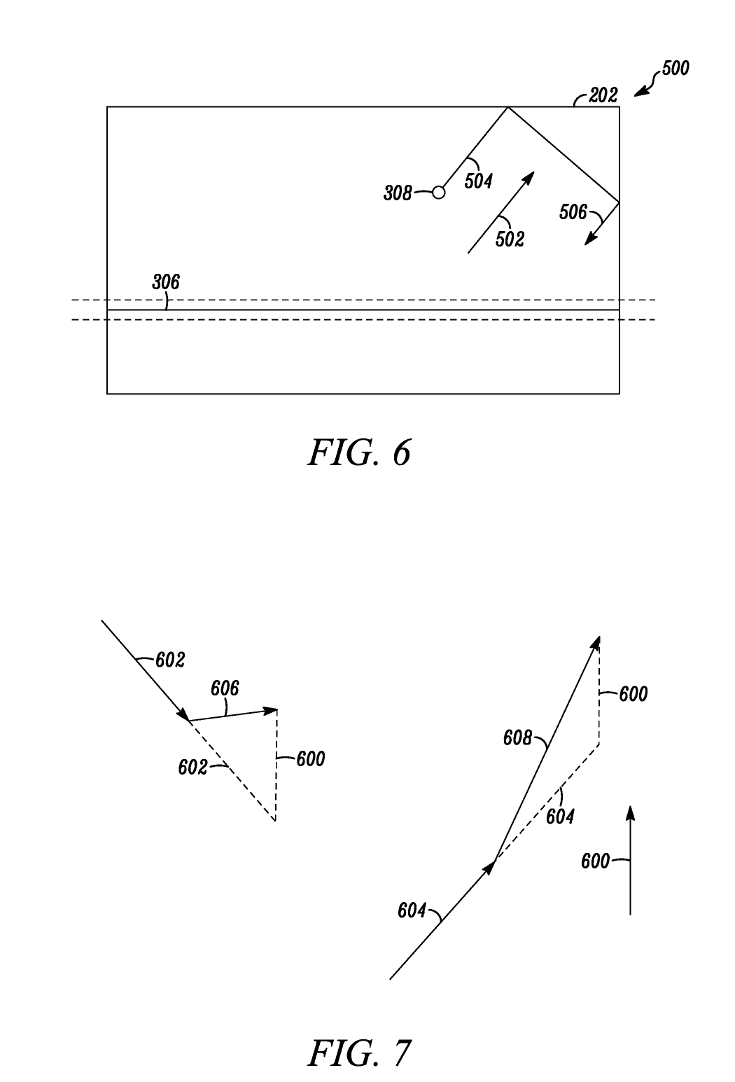

FIG. 6 illustrates the effects of the same exemplary vector 600 relative to a pair of different initial vectors 602 and 604. The resulting vectors 606 and 608 are determined by respectively adding the exemplary vector 600 to each of the initial vectors. The direction of the exemplary vector can be determined by looking at a gesture that is detected proximate the display surface of the touch sensitive display. In at least one instance, the direction can be determined by drawing a straight line between the beginning point and the end point of the detected gesture. However one skilled in the art can readily appreciate that the detected gesture can be analyzed in alternative ways for determining a direction without departing from the teachings of the present disclosure. While in some instances the magnitude of the exemplary vector to be used to adjust the velocity of the display element is fixed and/or static, it is alternatively possible that a magnitude of the exemplary vector could be derived from features associated with the detected gesture, where the magnitude of the velocity could be based upon the overall length of the gesture, or some other derivable metric.

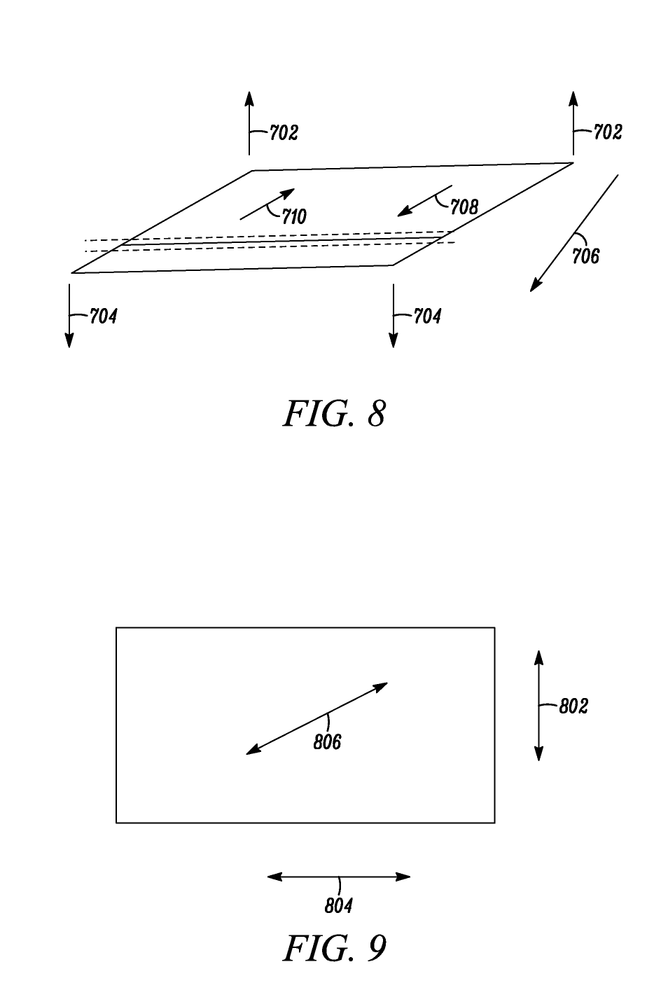

In addition to a detected gesture, the velocity of the display element could additionally or alternatively be affected by an amount that the device is twisted, turned or tilted. For example, the user interface 200 may additionally include a movement sensor 218 which could detect movement of the device. At least a couple of examples of movement sensors include tilt sensor(s) 220 and accelerometer(s) 222, see FIG. 3. One skilled in the art will readily appreciate that the use of other types of movement sensors are possible without departing from the teachings of the present disclosure. For example as illustrated in FIG. 8, by raising 702 one or more corners of the device relative to one or more other corners of the device which are respectively lowered 704, a corresponding tilt 706 can be produced which could be detected and used to produce a vector which could be used to alter the current velocity of a display element. Where a tilt produces a vector to be used to adjust the velocity of the display element in the same direction as the tilt, the vector will generally add to the velocity, in instances where the display element is moving in a downward direction 708 relative to the tilt. Alternatively the vector would generally subtract from the velocity of the display element, where the display element is moving in an upward direction 710 relative to the tilt. It is further possible that, the twisting, turning or tilting can be in other directions other than in an upward or downward direction 802, including a relative movement in a leftward or rightward direction 804, as well as movement in a direction that extends diagonally 806. It is further possible that the device can be shaken to induce a general increase or decrease in the overall velocity.

By providing a variable start zone for a display element 308 where the position of the display element changes as a function of time, and the display element generally follows a pattern having a predetermined manner where the direction changes as it traverses the lock area, multiple repeated unintended gestures which are received will have an effect which will generally cancel out thereby limiting the chances that these unintended detected interactions will serve to unintentionally unlock the device. Still further, the interaction necessary from the user to transition the device from a locked state to an unlocked state is still relatively straight forward and intuitive so as to not be overly complex.

In at least some embodiments, the controller 204 illustrated in FIG. 3 could be implemented in the form of a microprocessor, which is adapted to execute one or more sets of prestored instructions, which may be used to form at least part of one or more controller modules 210, 212 and/or 214. The one or more sets of prestored instructions may be stored in a storage element, not shown, which may be integrated as part of the controller or may be coupled to the controller 204.

A storage element could include one or more forms of volatile and/or non-volatile memory, including conventional ROM, EPROM, RAM, or EEPROM. The storage element may still further incorporate one or more forms of auxiliary storage, which is either fixed or removable, such as a harddrive or a floppydrive. One skilled in the art will still further appreciate, that still other further forms of memory could be used without departing from the teachings of the present disclosure. In the same or other instances, the controller 206 may additionally or alternatively incorporate state machines and/or logic circuitry, which can be used to implement at least partially, some of modules and their corresponding functionality.

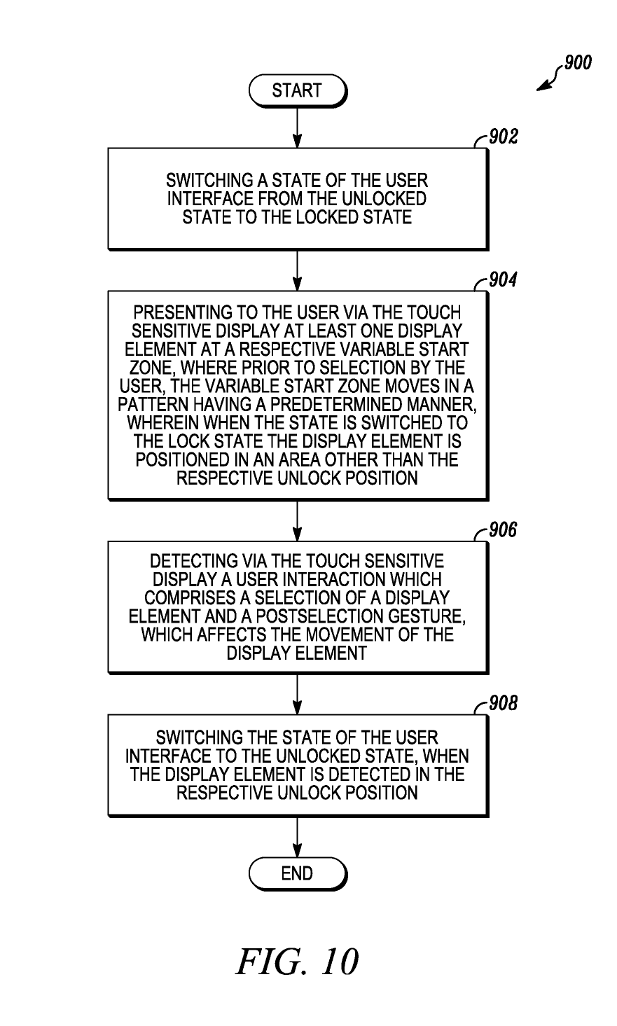

FIG. 10 illustrates a flow diagram of a method 900 for managing a state of a user interface between a locked state and an unlocked state. The method includes, at 902, switching a state of the user interface from the unlocked state to the locked state. At 504, at least one display element is presented to the user via the touch sensitive display at a respective variable start zone, where prior to selection by the user, the variable start zone moves in a pattern having a predetermined manner. When the state of the user interface is switched to a locked state, the at least one display element is positioned in an area other than the respective unlock position. At 906, a user interaction is then detected via the touch sensitive display, which includes a selection of a display element and a postselection gesture which affects the movement of the display element. At 508, the state of the user interface is switched to an unlocked state when the display element is detected in the respective unlock position.

When in a locked state, at least a portion of the types of interactions that are generally allowed are restricted. This can include all general access to the device with the exception of the actions which are interpreted in association with any perceived attempted unlocking of the device, or it can include access to one or more features or functions including access to one or more applications operating on the device. Access to these portions of the user interface will generally be restricted until the user interface is placed in an unlocked state, through the user executing a set of one or more actions relative to the device which triggers an unlocking of the user interface. In this way, unintended interactions which can trigger unintended consequences can be reduced.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A user interface for an electronic device comprising:
a touch sensitive display having a display surface, the touch sensitive display being adapted for presenting to a user at a respective position at least one display element along the display surface, and the touch sensitive display being further adapted for receiving from the user a user interaction with the touch sensitive display at a location along the display surface;
a controller including
a user interface state module having an unlock state and a lock state adapted for selectively enabling and disabling at least a portion of the user interface, wherein the portion of the user interface responds to a predetermined type of user interaction when in the unlock state and does not respond to the predetermined type of user interaction when in the lock state;
a state change module adapted for switching the state of the user interface state module between the lock state and the unlock state, wherein the state change module switches the state of the user interface module from the lock state to the unlock state when the state change module detects each of the at least one display elements in respective unlock position for the corresponding one of the at least one display elements, and wherein the respective unlock position for the corresponding one of the at least one display element includes placement within a respective predetermined area; and
a lock state interface module, said lock state interface module being adapted to detect a received user interaction that is initiated with a selection of one of the at least one display element having a variable start zone, the lock state interface module including a start zone movement module, where prior to the selection of the display element by the user, the variable start zone of the display element moves in a pattern having a predefined manner along the display surface as a function of time, such that the variable start zone has a first location relative to the display surface at a first point in time, and the variable start zone has a second location relative to the display surface at a second point in time, which is different than the first location.

2. A user interface for an electronic device in accordance with claim 1, wherein the received user interaction includes a post selection gesture, which moves the selected one of the at least one display element from the variable start zone to a post gesture position having a placement in a new area.

3. A user interface for an electronic device in accordance with claim 1, wherein the display surface is divided into two areas, a first area corresponding to the variable start zone of the at least one display element, and a second area corresponding to the unlock position of the at least one display element.

4. A user interface for an electronic device in accordance with claim 3, wherein the first area is larger than the second area.

5. A user interface for an electronic device in accordance with claim 3, wherein the display area further includes a boundary line separating the two areas.

6. A user interface for an electronic device in accordance with claim 5, wherein the variable start zone of the at least one display element is repelled by the boundary line separating the two areas.

7. A user interface for an electronic device in accordance with claim 6, wherein repelling of the display element by the boundary line includes biasing the at least one display element away from crossing over the boundary line between first area of the display and the second area of the display surface.

8. A user interface for an electronic device in accordance with claim 7, wherein when a movement of the at least one display element results in the at least one display element approaching the boundary line, if a rate of movement of the at least one display element in a direction perpendicular to the boundary exceeds a minimum threshold, then the at least one display element will cross the boundary, and if the rate of movement of the at least one display element in the direction perpendicular to the boundary does not exceed the minimum threshold, then the at least one display element will reflect off of the boundary.

9. A user interface for an electronic device in accordance with claim 1, wherein the received user interaction includes a post selection gesture, which includes a path having a direction which is traced proximate the display surface of the touch sensitive display by the user using a pointer having a position that moves along the path, wherein a further movement of the variable start zone of the at least one display element is biased in the direction of the path of the post selection gesture.

10. A user interface for an electronic device in accordance with claim 1, further comprising a movement sensor, for detecting a movement of the electronic device initiated by the user.

11. A user interface for an electronic device in accordance with claim 10, wherein the movement sensor includes a tilt sensor, which detects the relative tilt away from an orientation of the electronic device defined as being level, and wherein a rate of a movement of the variable start zone of the at least one display element is biased in a downward direction of the detected tilt.

12. A user interface for an electronic device in accordance with claim 10, wherein the movement sensor is adapted to detect a shaking by the user of the electronic device, wherein a magnitude of the shaking is compared to a rate of a movement of the variable start zone of the at least one display element, and if the magnitude of the shaking is greater than the rate of the movement, then the rate of the movement of the variable start zone of the at least one display element is increased.

13. A user interface for an electronic device in accordance with claim 10, wherein the movement sensor is an accelerometer.

14. A method for managing a state of a user interface between a locked state and an unlocked state, the method comprising:
switching a state of the user interface from the unlocked state to the locked state;
presenting to the user via a display surface of a touch sensitive display at least one display element, each of the at least one display element being presented at a respective variable start zone, where prior to selection by the user, the variable start zone of the display element moves in a pattern having a predetermined manner along the display surface as a function of time, such that the variable start zone has a first location relative to the display surface at a first point in time, and the variable start zone has a second location relative to the display surface at a second point in time, which is different than the first location, wherein when the state of the user interface is switched from the unlocked state to the locked state, the at least one display element is positioned in an area of the display surface other than a predetermined area of a respective unlock position;
detecting via the touch sensitive display a user interaction proximate the display surface, the user interaction comprising a selection by the user of one of the at least one display element and a postselection gesture, which affects the movement of the display element; and
switching the state of the user interface from the locked state to the unlocked state, when each of the at least one display element is detected in the respective unlock position of the corresponding at least one display element.

15. A method for managing a state of a user interface in accordance with claim 14, wherein the received user interaction includes a post selection gesture, which moves the selected one of the at least one display element from the variable start zone to a post gesture position having a placement in a new area

16. A method for managing a state of a user interface in accordance with claim 14, wherein the received user interaction includes a post selection gesture, which includes a path having a direction which is traced proximate the display surface of the touch sensitive display by the user using a pointer having a position that moves along the path, wherein a further movement of the variable start zone of the at least one display element is biased in the direction of the path of the post selection gesture.

17. A method for managing a state of a user interface in accordance with claim 14, further comprising detecting a movement of the electronic device initiated by the user, and adjusting the further movement of the variable start zone, based upon the detected movement of the electronic device.

18. A method for managing a state of a user interface in accordance with claim 14, wherein detecting a movement of the electronic devices includes detecting the relative tilt away from an orientation of the electronic device defined as being level, and wherein a rate of a movement of the variable start zone of the at least one display element is biased in a downward direction of the detected tilt

19. A method for managing a state of a user interface in accordance with claim 14, wherein detecting a movement of the electronic devices includes detecting a shaking by the user of the electronic device, wherein a magnitude of the shaking is compared to a rate of a movement of the variable start zone of the at least one display element, and if the magnitude of the shaking is greater than the rate of the movement, then the rate of the movement of the variable start zone of the at least one display element is increased.

20. A method for managing a state of a user interface in accordance with claim 14, further comprising transitioning across a boundary the position of the at least one display element between a first area corresponding to the variable start zone of the at least one display element, and a second area corresponding to the unlock position of the at least one display element, wherein when a movement of the at least one display element results in the at least one display element approaching the boundary line, if a rate of movement of the at least one display element in a direction perpendicular to the boundary exceeds a minimum threshold, then the at least one display element will cross the boundary, and if the rate of movement of the at least one display element in the direction perpendicular to the boundary does not exceed the minimum threshold, then the at least one display element will reflect off of the boundary.
